(19) United States
(12) Patent Application Publication
(10) Pub. No.: US 2025/0226642 A1
(43) Pub. Date: Jul. 10, 2025

(54) PARTING CABLE STRIPPER

(71) Applicant: Huyu DU, Pizhou (CN)

(72) Inventor: Huyu DU, Pizhou (CN)

(21) Appl. No.: 18/404,078

(22) Filed: Jan. 4, 2024

(30) Foreign Application Priority Data
Nov. 14, 2022 (CN) 202223020165.4

(51) Int. Cl. H02G 1/12

(52) U.S. Cl. CPC H02G 1/1212

(57) ABSTRACT

A multifunctional center parting cable stripper relating to the field of cable strippers is provided and includes a clamp body, a spring, a hollow rivet part, a pressing part, a cutting part, a stripping part, and a clamping part. The clamp body includes an upper clamp body and a lower clamp body, and the upper clamp body and the lower clamp body define hexagonal bolt holes individually. The spring is disposed between the upper clamp body and the lower clamp body, and the hollow rivet part configured to fix the upper clamp body and the lower clamp body is disposed on shaft-receiving parts of the upper clamp body and the lower clamp body. The pressing part, the cutting part, the stripping part, and the clamping part are disposed on the clamp body. The upper clamp body defines cable-twisting-winding holes.

### TECHNICAL FIELD

The disclosure relates to the field of cable strippers, and particularly to a parting cable stripper.

### BACKGROUND

Cable strippers are one kind of commonly used tools for internal electricians, electric motor repairs, and instrumentation electricians. The cable strippers on the market have a single structure and often require tool replacement during use, which is inconvenient to use. Especially for some special occasions such as high-altitude operations, the replacement of different tools during using the cable stripper not only prolongs the operation time but also increases more risks.

Chinese patent with publication No. CN217182800U discloses a novel multifunctional cable stripper. The novel multifunctional cable stripper has an electrical measurement function by providing a digital screen and a circuit board. The novel multifunctional cable stripper has certain advantages, but it is only provided additional functions based on the original cable stripper, which cannot solve disadvantages of frequent tool replacement and inconvenient use. Therefore, the disclosure provides a multifunctional center parting cable stripper, which can effectively reduce the time of frequent replacement of different tools and save operating time.

### SUMMARY

To address the shortcomings of the related art, the disclosure provides a multifunctional center parting cable stripper (i.e., a parting cable stripper).

To achieve the above objective or other objectives, the disclosure proposes technical solutions as follows.

A multifunctional center parting cable stripper is provided and includes: a clamp body, a spring, a hollow rivet part, a pressing part, a cutting part, a stripping part, and a clamping part. The clamp body includes: an upper clamp body and a lower clamp body, and the upper clamp body and the lower clamp body define hexagonal bolt holes individually. The spring is disposed between the upper clamp body and the lower clamp body, and the hollow rivet part configured to fix the upper clamp body and the lower clamp body is disposed on shaft-receiving parts of the upper clamp body and the lower clamp body.

The pressing part, the cutting part, the stripping part, and the clamping part are disposed on the clamp body.

The upper clamp body defines cable-twisting-winding holes.

The multifunctional center parting cable stripper further includes: a closing-locking plate disposed on an overlapping part between the upper clamp body and the lower clamp body.

The hexagonal bolt holes of each of the upper clamp body and the lower clamp body are different.

The hollow rivet part includes: two hollow rivets locked with each other; and the two hollow rivets form a fixed shaft with a hollow structure, the hollow rivet part is configured to fix the upper clamp body and the lower clamp body through the fixed shaft, and the multifunctional center parting cable stripper further includes: a cable-parting blade disposed on the hollow structure of the hollow rivet part and configured to part cables.

Compared with the related art, beneficial effects of the disclosure are follows.

1. The multifunctional center parting cable stripper of the disclosure includes a novel clamp body, the novel clamp body defines the hexagonal bolt holes with different standards, and the hexagonal bolt holes can be used to directly disassemble the corresponding hexagonal bolts.

2. The spring is disposed between the upper clamp body and the lower clamp body, which enables the cable stripper to automatically reset after removing external forces, making it convenient for use.

3. The multifunctional center parting cable stripper of the disclosure has complete functions of integrating clamping, stripping, cutting, twisting, winding, and pressing through providing a pressing part, a cutting part, a stripping part, and a clamping part. The functions are relatively complete and the multifunctional center parting cable stripper is convenient to use, which solves the problem of frequent tool replacement.

4. The upper clamp body and the lower clamp body are connected by using a hollow rivet part, and a cable-parting blade is embedded in a hollow structure of the hollow rivet part. The hollow rivet part includes two functions: (1) connecting the upper clamp body and the lower clamp body; and (2) matching with the cable-parting blade to part cables. The hollow rivet part having the two functions can replace a solid rivet having a single function of connecting the upper clamp body and the lower clamp body.

### BRIEF DESCRIPTION OF DRAWINGS

FIG. 1 illustrates a schematic structural diagram of a multifunctional center parting cable stripper of the disclosure.

FIG. 2 illustrates another schematic diagram of the multifunctional center parting cable stripper of the disclosure.

In the attached drawings, description of numeral references is listed as follows:

1. clamp body;

101. upper clamp body;

102. lower clamp body;

103. hexagonal bolt hole;

2. spring;

3. hollow rivet part;

4. cable-parting blade;

5. pressing part;

6. cutting part;

7. stripping part;

8. clamping part;

9. cable-twisting-winding hole;

10. closing-locking plate.

### DETAILED DESCRIPTION OF EMBODIMENTS

Further explanation of the disclosure will be provided in conjunction with the attached drawings and specific embodiments. It should be understood that these embodiments are only used to illustrate the disclosure and not to limit the scope of the disclosure. In addition, it should be understood that after reading the content taught in the disclosure, those skilled in the art can make various amendments or modifications to the disclosure, and these equivalent forms also fall within the scope limited by the disclosure.

The standard parts used in the disclosure can be purchased from the market, and the irregular parts can be customized according to the specification and the attached drawings. The specific connection methods of the parts adopt mature conventional methods such as bolts, rivets, welding, and pasting in the related art. In addition. The attached drawings of the disclosure have been organized and drawn in a form of a schematic diagram of mechanism motion to clearly express the connection relationship between the parts and working principle of the parts, and will not be elaborated here.

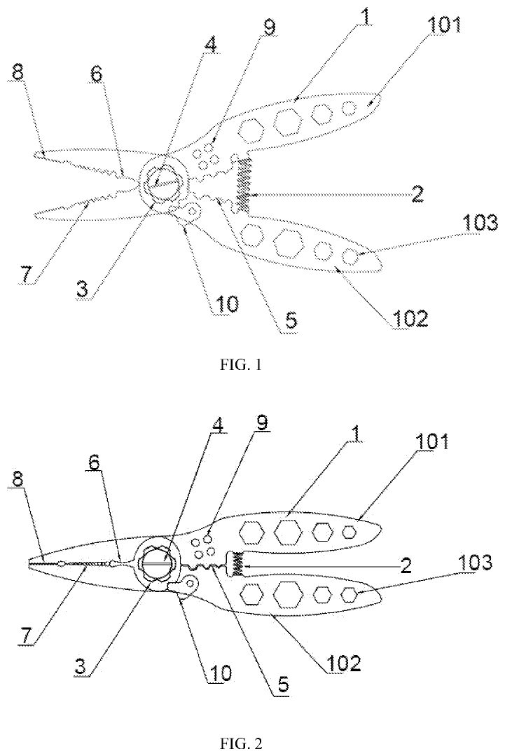

As shown in FIGS. 1-2, a multifunctional center parting cable stripper is provided and includes a clamp body 1, a spring 2, a hollow rivet part 3, a pressing part 5, a cutting part 6, a stripping part 7, and a clamping part 8. The clamp body 1 includes an upper clamp body 101 and a lower clamp body 102, and the upper clamp body 101 and the lower clamp body 102 define hexagonal bolt holes 103 individually. The spring 2 is disposed between the upper clamp body 101 and the lower clamp body 102, and the hollow rivet part 3 configured to fix the upper clamp body 101 and the lower clamp body 102 is disposed on shaft-receiving parts of the upper clamp body 101 and the lower clamp body 102. The shaft-receiving part of each of the upper clamp body 101 and the lower clamp body 102 may be a hole for receiving the hollow rivet part 3.

The pressing part 5, the cutting part 6, the stripping part 7, and the clamping part 8 are disposed on the clamp body 1.

The upper clamp body 101 defines cable-twisting-winding holes 9.

In a specific embodiment, the multifunctional center parting cable stripper further includes: a closing-locking plate 10, which is disposed on an overlapping part between the upper clamp body 101 and the lower clamp body 102 to further fix the upper clamp body 101 and the lower clamp body 102, thereby preventing a relative loosening between the upper clamp body 101 and the lower clamp body 102 in use.

In an embodiment, the hexagonal bolt holes 103 of each of the upper clamp body 101 and the lower clamp body 102 are different standards. When in use, the multifunctional center parting cable stripper can be used to disassemble hexagonal bolts with the different standards corresponding to the hexagonal bolt holes, which makes the functions of the multifunctional center parting cable stripper more complete.

In an embodiment, the hollow rivet part 3 includes: two hollow rivets locked with each other. The two hollow rivets form a fixed shaft with a hollow structure, and the hollow rivet part 3 is configured to fix the upper clamp body 101 and the lower clamp body 102 through the fixed shaft; and the multifunctional center parting cable stripper further includes: a cable-parting blade 4 disposed on the hollow structure of the hollow rivet part and configured to part cables. The arrangement makes the upper clamp body 101 and lower clamp body 102 to be firmly fixed and constrained through the fixed shaft formed by the two hollow rivets of the hollow rivet part 3.

A working principle of the multifunctional center parting cable stripper is as follows: when using the multifunctional center parting cable stripper, different structures are used to achieve the different functions, which greatly solves the problem of frequent replacement of different tools for operation. During an operation of parting cables, the operation can be achieved by holding the front ends of the upper clamp body and the lower clamp body of the multifunctional center parting cable stripper. When a hexagonal bolt need to be disassembled, the disassembly of the hexagonal bolt can be achieved by holding the rear ends of the upper clamp body and the lower clamp body of the multifunctional center parting cable stripper, but sharp parts of the rear ends of the upper clamp body and the lower clamp body of the multifunctional center parting cable stripper should be noticed to prevent from scratching the hand. When applying pressure, the object can be tightly clamped by the pressing part through holding the rear ends of the upper clamp body and the lower clamp body of the multifunctional center parting cable stripper. When stripping the cable, the rubber cable is clamped by the stripping part through holding the front ends of the upper clamp body and the lower clamp body, then the multifunctional center parting cable stripper is pulled outwards or diagonally backwards to strip the rubber cable. When cutting the cable, the cable cutting or the iron cable cutting can be achieved by firmly holding the rear ends of the upper clamp body and the lower clamp body of the multifunctional center parting cable stripper. When parting the cable, the cable is inserted into the hollow structure of the hollow rivet part with the clamp body closed, followed by pushing the cable forward to be separated by the cable-parting blade. The hollow rivet part plays a role in connecting the two clamp bodies and is further reinforced by the closing-locking plate. The hollow rivet part of the disclosure replaces the existing solid rivet and has the function of connecting the two clamp bodies, and further provides a hollow space to set the cable-parting blade.

What is claimed is:

1. A parting cable stripper, comprising: a clamp body (1), a spring (2), a hollow rivet part (3), a pressing part (5), a cutting part (6), a stripping part (7), and a clamping part (8); wherein the clamp body (1) comprises: an upper clamp body (101) and a lower clamp body (102), and the upper clamp body (101) and the lower clamp body (102) define hexagonal bolt holes (103) individually; and the spring (2) is disposed between the upper clamp body (101) and the lower clamp body (102), and the hollow rivet part (3) configured to fix the upper clamp body (101) and the lower clamp body (102) is disposed on shaft-receiving parts of the upper clamp body (101) and the lower clamp body (102);
wherein the pressing part (5), the cutting part (6), the stripping part (7), and the clamping part (8) are disposed on the clamp body (1); and
wherein the upper clamp body (101) defines cable-twisting-winding holes (9).

2. The parting cable stripper as claimed in claim 1, further comprising: a closing-locking plate (10) disposed on an overlapping part between the upper clamp body (101) and the lower clamp body (102).

3. The parting cable stripper as claimed in claim 1, wherein the hexagonal bolt holes (103) of each of the upper clamp body (101) and the lower clamp body (102) are different.

4. The parting cable stripper as claimed in claim 1, wherein the hollow rivet part (3) comprises: two hollow rivets locked with each other; the two hollow rivets form a fixed shaft with a hollow structure, and the hollow rivet part (3) is configured to fix the upper clamp body (101) and the lower clamp body (102) through the fixed shaft; and the parting cable stripper further comprises: a cable-parting blade (4) disposed on the hollow structure of the hollow rivet part and configured to part cables.
